(19) United States
(12) Patent Application Publication
(10) Pub. No.: US 2009/0011192 A1
(43) Pub. Date: Jan. 8, 2009

(54) Method, system, and apparatus for producing dimensional image articles utilizing a cushioning assembly

(76) Inventors: John Tomczyk, Shoreview, MN (US); David L. Williams, Prescott, WI (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/824,849

(22) Filed: Jul. 3, 2007

(51) Int. Cl. B32B 3/00

(52) U.S. Cl. 428/172; 156/219; 156/583.3

(57) ABSTRACT

Methods, apparatus, and system for a protecting an optical lens material during formation of a dimensional image article. A heat compression laminator including a cushioning assembly provides an insulating barrier between the lower compression assembly of the heat compression laminator and the individual lenses of an optical lens material, such as the lenticules on a lenticular lens material. The cushioning web protects the optical lens material so as to prevent significant deformation during the application of heat and pressure in a laminating step. Use of the cushioning web can be especially advantageous during formation of clear, transparent, or semi-transparent dimensional image articles.

### FIELD OF THE INVENTION

The present invention relates generally to a product, process and system for printing and making a dimensional image article. More particularly, the present invention is directed to printed dimensional image articles having heat activated adhesives and related processes and systems for the preparation of printed dimensional image articles without lens deformation as described herein.

### BACKGROUND OF THE INVENTION

The use of dimensional image material, such as lenticular lens material, is known in the printing industry for use in creating a variety of dimensional image articles and products. Dimensional image articles can include, but are not limited to, lenticular articles. Dimensional image printing processes can involve printing onto a sheet of optical lens material and, in some applications, adhesively attaching the optical lens material to a separately produced object for use or display. Other processes create complete dimensional image or lenticular articles, such as some types of containers and cards, that do not require adhesion to separately produced objects, and may or may not be coated or finished on the back.

In general, a dimensional image production process includes selecting segments from visual images to create a desired visual effect and interlacing the segments (i.e., planning the layout of the numerous images). For example, the production of lenticular lenses is well known and described in detail in a number of U.S. patents, including U.S. Pat. No. 5,967,032, which is incorporated herein by reference. Lenticular lenses generally include a transparent substrate which has a flat side or layer and a side with optical ridges and grooves which form lenticules (i.e., convex lenses) arranged side-by-side, with the lenticules or optical ridges extending parallel to each other. Images can then be interlaced or mapped to the dimensional imaging lens or lenses to print under the lenses or lenticules. To provide the unique visual effects associated with dimensional imaging, ink is applied or printed directly to the flat side of the transparent substrate to form the interlaced segments. The dimensional imaging material is often times subsequently combined with to a backing by an adhesive to form a dimensional image card, such as a lenticular card, as described in detail in U.S. Pat. Nos. 6,900,944 and 7,075,725, which are incorporated herein by reference. Such cards can additionally include a magnetic stripe and can be used as credit or debit cards, gift cards, phone cards, promotional cards, posters, loyalty cards, rewards cards, postcards, and the like.

The backing of the dimensional imaging card generally comprises a rigid backing material such as, for example, plastic, paperstock or the like. A non-laminated surface of the backing, generally on an opposed side to the dimensional lens material, is frequently printed with indicia such as, for example, graphic art, legal information, telephone numbers, addresses, company information, patent numbers, pin numbers, activation numbers, and the like. Following printing, the previously non-laminated surface can then be subsequently laminated with an overlay film to protect the printing and form a printed surface. In addition or alternatively, an overlay film can be used for placement of a magnetic stripe.

Generally, the overlay film is laminated to the printed surface of the backing by an adhesive coating, such as, for example, a water-based adhesive or solvent-based adhesive. The overlay film can be laminated by a known compression techniques such as compression, such as with a platen press, nipping, belt laminating with a belt laminator, and other such lamination techniques known in the art. In addition to joining the overlay coating, the adhesive coating also acts as a protective layer and generally prevents blistering or lifting of the clear overlay providing a bond to the printed ink.

It is often desirable to use a heat-activated adhesive in place of the water-based adhesive to combine the dimensional imaging material, such as the lenticular lens material, to the backing, and/or to laminate an overlay film to the backing. Conventional water-based adhesives used to combine the dimensional imaging material and the backing or laminate the overlay film to the backing, may not cure clearly and can result in a “cobweb” or “spider web” appearance which negatively impacts the appearance of the dimensional card. This is especially an issue when manufacturing a clear, transparent, or semi-transparent lenticular card. Heat-activated adhesives, on the other hand, tend to cure substantially transparent, resulting in a transparent or semitransparent card. Heat-activated adhesives also tend to create a destructive bond between the dimensional imaging material and the backing.

Unfortunately, the combination of heat and pressure used in lamination processes utilizing heat-activated adhesives can result in lens deformation when laminating a dimensional article. In particular, the lenticules of a lenticular card can be deformed, flattened, and the like, thereby reducing the image quality, even to the point where the image is not seen at all.

Consequently, there remains a need for an improved dimensional article, manufacturing process, and system. In particular, a need remains for processes and methodologies that prevent lens deformation during a lamination step involving heat-activated adhesives.

### SUMMARY OF THE INVENTION

The invention resolves many of the above described deficiencies and drawbacks inherent with dimensional image article manufacturing processes. In particular, various embodiments of the invention are directed to a processing method as well as related products and systems for combining an optical lens material with a backing sheet, and laminating overlay films to form dimensional image articles using heat-activated adhesives and pressure while avoiding lens deformation.

In one representative embodiment of the invention, a dimensional image article can comprise a backer sheet, an optical lens material, a first ink layer, and a first adhesive layer. In some embodiments, the dimensional image article can further comprise a second adhesive layer, and an overlay film. The backer sheet can comprise a first major surface and second major surface. The optical lens material can comprise a ridged lens surface and a flat lens surface. The first ink layer can be printed on the flat lens surface to define a dimensional image. The first adhesive layer can include a first heat activated adhesive attaching the first major surface of the backer sheet to the flat lens surface of the optical lens material. The second adhesive layer can include a second heat activated adhesive to operably join the overlay film to the second major surface of the backer sheet. In some embodiments, a second ink layer can be printed on the second major surface of the backer sheet to define a printed indicia. In some embodiments, the overlay film can include the second adhesive layer. In some embodiments, the optical lens material can comprise lenticular lens material defining a plurality of lenticules. In some embodiments, the dimensional image can comprise an interlaced image. In some embodiments, the backer sheet, the first adhesive layer, the second adhesive layer, and the overlay film can be transparent or semitransparent.

In another representative embodiment of the invention, a method for making a high quality dimensional article with an overlay film, and a transparent lenticular article with a lenticular lens material, a clear backer sheet and overlay film, includes printing a non-dimensioned side of the optical lens material and a back side of the backer sheet, applying a heat activated adhesive between the optical lens material and the backer sheet, and the backer sheet and an overlay film, laminating the dimensional image assembly using a heat compression laminator having a cushioning assembly to form a laminated sheet, and converting the laminated sheet to form the dimensional image article. The cushioning material of the cushioning assembly provides adequate cushion and insulation so as to prevent deformation of individual lenses of the optical lens material, such as lenticules on the lenticular lens material, during the application of heat and pressure in the laminating step.

In yet another embodiment of the invention, a system for manufacturing a high quality dimensional article with an overlay film includes at least one print station, at least one adhesive application unit, a heat compression laminator having a cushioning assembly, and a converting station. The cushioning assembly includes a cushioning material so as to prevent significant lens deformation on a optical lens material during the application of heat and pressure in the laminating step.

The methods and systems of the present invention thereby provide a high resolution, low cost process for the creation of high quality lenticular images and articles without incurring lens deformation to a lenticular lens material.

The above summary of the invention is not intended to describe each illustrated embodiment or every implementation of the present invention. The figures and the detailed description that follow more particularly exemplify these embodiments.

### BRIEF DESCRIPTION OF THE DRAWINGS

FIG. 1 is a dimensional image article according to one embodiment of the invention.

FIG. 1A is a detailed view of the lenticule of FIG. 1 taken at detail 1A of FIG. 1.

FIG. 2 is a flow chart depicting a method of making a dimensional image article according to one embodiment of the invention.

FIG. 3 is a heat compression laminator system for making a dimensional image article according on one embodiment of the invention.

FIG. 4 is a detailed view of the heat compression laminator of FIG. 3 taken at detail 4 of FIG. 3.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE DRAWINGS

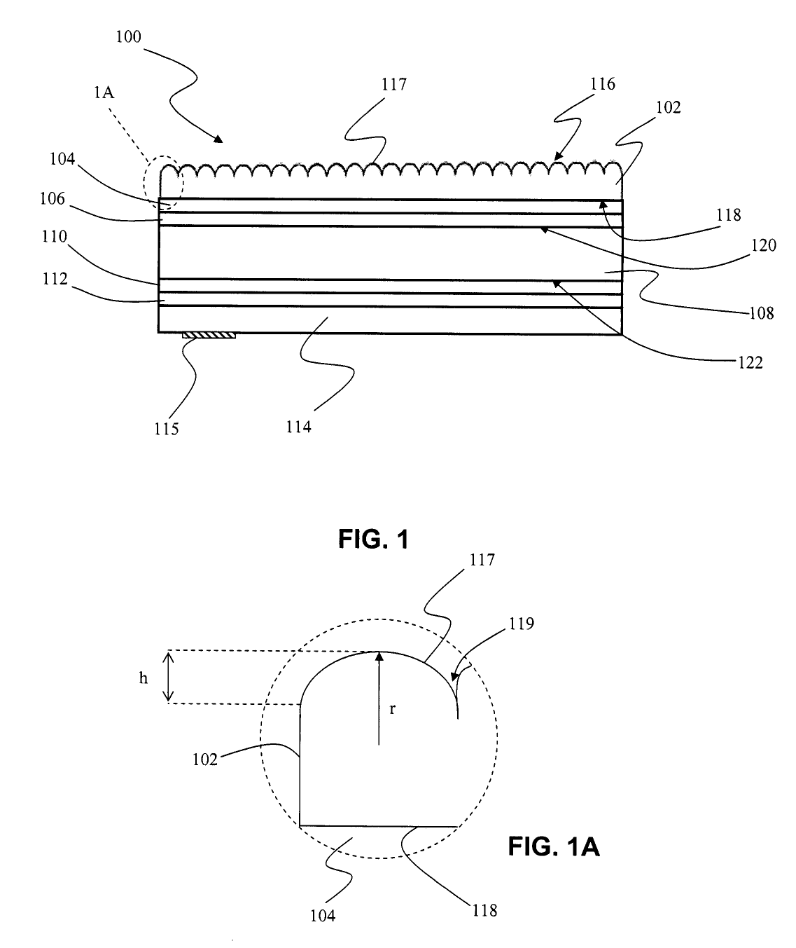

Referring to FIG. 1, a dimensional image article 100 manufactured according to the present invention generally comprises an optical lens material 102, a first ink layer 104, a first adhesive layer 106, and a backer sheet 108. In additional embodiments, dimensional image article 100 can further comprise a second ink layer 110, a second adhesive layer 112, and an overlay film 114. Additionally, an exterior surface of dimensional image article 100, such as, for example, overlay film 114, can comprise a data layer 115, such as, for example, a magnetic stripe, a printed bar code, an RFID chip, a serial or model number sequence, an activation code, a pin number, an account number, and the like for communicating, identifying, and/or storing information.

Dimensional image article 100 can comprise inserts, or blanks, such as labels, packaging, displays, credit or debit cards, gift cards, phone cards, promotional cards, posters, loyalty cards, rewards cards, postcards, and like items.

Optical lens material 102 can comprise a ridged lens surface 116 and an opposed substantially flat lens surface 118. In one respective embodiment, ridged lens surface 116 comprises a plurality of lenticules 117 having a radius of curvature “r”, and a ridge height “h”, to form a ridged lenticular surface, as depicted in FIG. 1A. Individual lenticules 117 can be separated by a void area 119. In some embodiments, lenticules 117 can occupy from about 10% to about 100% of ridged lens surface 116. Optical lens material 102 can comprise a material with suitable optical properties such as, for example, polypropylene, polycarbonate, PVC, PETG, amorphous polyester terephthalate (APET), PLA, and other suitable materials. Currently available methods can provide a lens sheet or lenticulated sheet array, which can vary in thickness, for example, from about 10 mil to about 50 mils. The thickness of extruded optical lens material 102 is suggested by the formula: (confirm this is still accurate—from the '944 and '725)

r=C×f

or

r=[(n′−n)/n′]×f

where r is the radius of curvature of a lenticular lens, C is a constant, f is the focal length of optimal focus thickness for the plastic used to form optical lens material 102, n′ is the index of refraction of the lens construction material, such as an extruded plastic, and n is index of refraction of air. From the formula it is evident that the thicker the plastic used to form lenticular lens material, the lower the pitch or lenticules per inch (LPI). The lower the pitch, the more coarse optical lens material 102. An especially coarse lenticular lens material can give undesirable visual effects, for example, distortion of an underlying image. The desired pitch for a card of approximately 3⅜″ by 2⅛″ is for example between about 70 LPI and about 140 LPI. A coarser lenticular lens material would require image graphics and text to be significantly large, to avoid undesirable lens effects. Thus to run a higher pitch, the lenticular lens material would need to be, for example, between 10 to about 18 mils thick. Although the lens thickness can vary, one representative embodiment of the invention includes a lens thickness between about 10 mils and about 30 mils. In one particular embodiment of the invention, lentciular lens material 102 comprises an 18 mil 75-LPI PVC lens, available from Goex of Janesville, Wis.

Referring again to FIG. 1, first ink layer 106 covers at least a portion of flat lens surface 118. In one representative embodiment, first ink layer 106 generally comprises interlaced images to form the lenticulated image of dimensional image article 100. First ink layer 106 can comprise any of a variety of suitable inks such as, for example, radiation curable inks, water-based inks, conventional inks, and the like. Inks suitable for use in the present invention are commercially available from, for example, Wykoff, INX of San Laendor, Calif., SUNCURE inks from Sun Chemical of Carlstadt, N.J., and Flint Inks, St. Paul, Minn.

Backer sheet 108 generally comprises a first major surface 120 and second major surface 122. Backer sheet 108 can comprise any of a variety of generally rigid sheets, such as, for example, sheets comprising paper, resin, plastic, glass, rubber, metal, alloy, or combinations thereof. Backer sheet 108 can be, for example, polystyrene, polyvinyl chloride (PVC), PVC laminated polystyrene, compression laminated polystyrene, compression laminated PVC, PLA, polyester, polyolefins such as polyethylene, polypropylene, and the like, ABS, acrylics, epoxies, polyurethanes, polycarbonates, or combinations or laminates thereof. Backer sheet 108 can be, for example, opaque, transparent or semi-transparent. In one representative embodiment, backer sheet 108 can comprise a transparent 10 mil PVC sheet from Klockner Pentaplast of Montabaur, Germany.

Backer sheet 108 can be printed with second ink layer 110 over at least a portion of first major surface 120 and/or second major surface 122. Second ink layer 110 can comprise images, text, indicia, and the like. Second ink layer 110 can comprise any of a variety of suitable inks such as, for example, radiation curable inks, water-based inks, conventional inks and the like, as described above. As described throughout the application, second ink layer 110 can comprise a single layer, though alternatively, it can be understood to comprise a plurality of individually printed layers.

In an alternative example, second major surface 122 of backer sheet 108 and/or ridged lens surface 116 can be printed after backer sheet 108 and optical transparent material 102 are combined. For example, a subsequent concealing layer can be printed on ridged lens surface 116, as described in U.S. application Ser. No. 11/555,529, entitled “Articles Including Removable Concealing Layers and Methods of Printing the Same,” incorporated herein by reference in its entirety.

First adhesive layer 106 is sandwiched between second surface 118 of optical lens material 102 and first surface 120 of backer sheet 108. First adhesive layer 106 can comprise can comprise a heat activated adhesive that cures to form a substantially clear or transparent layer, and specifically avoids formation of the “cobweb” effect as described above. In one representative embodiment, first adhesive layer 106 comprises a water-based heat activated adhesive that cures to form a substantially clear or transparent adhesive layer, such as FM Group Wink 8600 and 8601.

Second adhesive layer 112 covers at least a portion of second major surface 122 of backer sheet 108. Second adhesive layer 112 can comprise a heat activated adhesive that cures to form a substantially clear or transparent layer, and specifically avoids formation of the “cobweb” effect as described above. A suitable heat activated adhesive is W35 adhesive from Waytech.

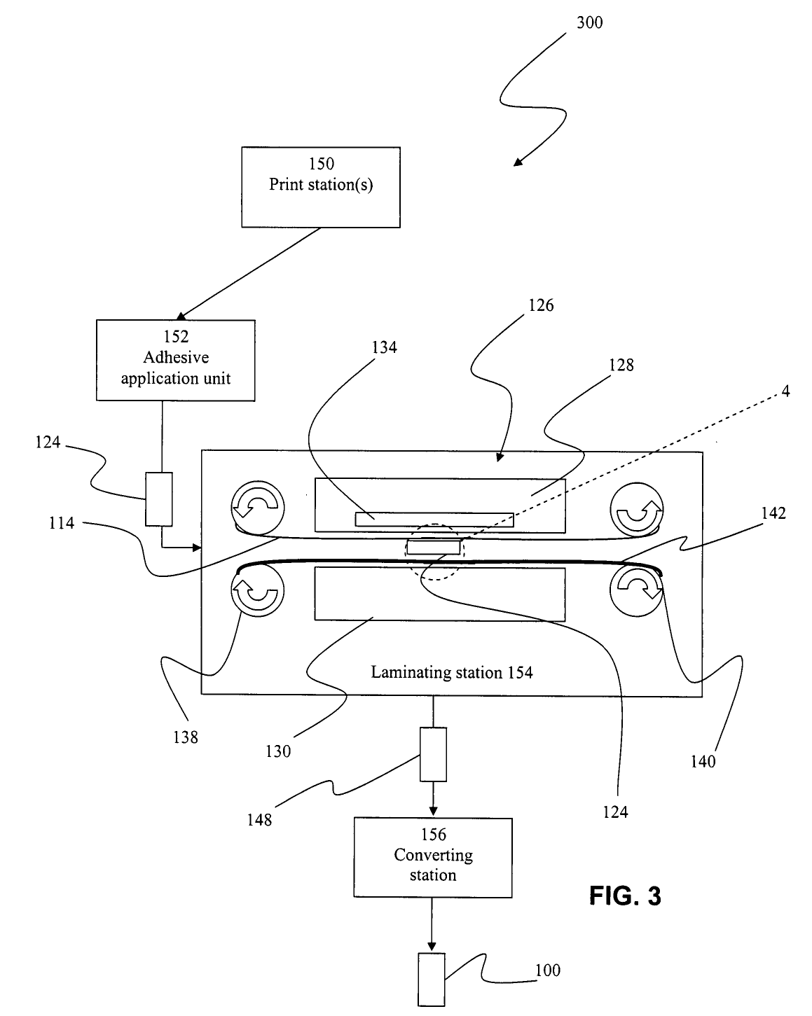

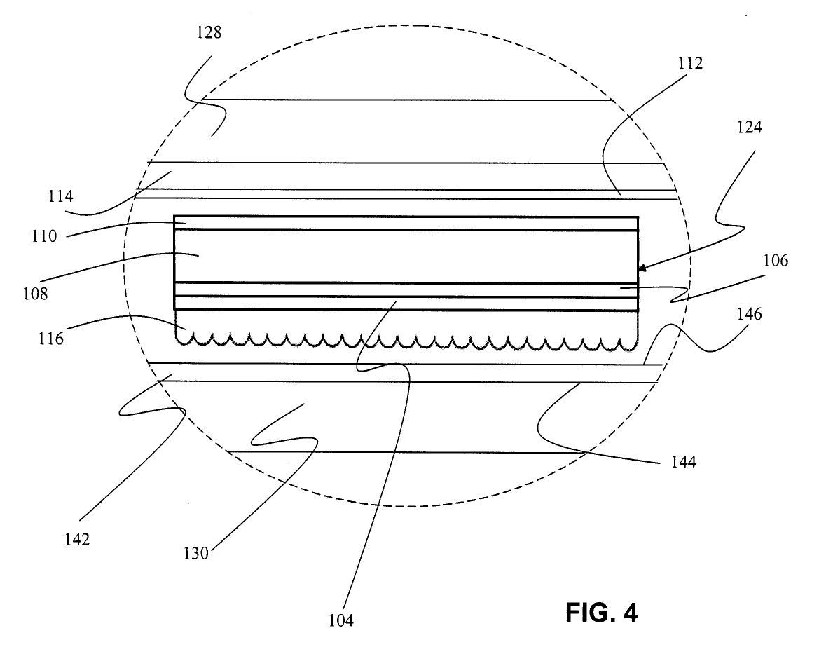

Overlay film 114 overlays second major surface 122 and sandwiches adhesive layer 112 between overlay film 114 and backer sheet 108. Overlay film 114 can comprise any of a variety of suitable transparent films in either web form, or individual sheets. Overlay film 114 is depicted as a web in FIGS. 3 and 4 for exemplary purposes only and is not limited to such. In one representative embodiment, overlay film is a 1.6 mil PVC film available from Klockner. Overlay film 114 protects second print layer 110 and also acts to provide a clean, level surface for optional applications of imaging or encoding with data layer 115, such as, for example, a magnetic stripe, a printed bar code, an RFID chip, a serial or model number sequence, an activation code, a pin number, an account number, and the like. Generally, overlay film 114 is pre-coated with second adhesive layer 112 on at least one major surface of overlay film.

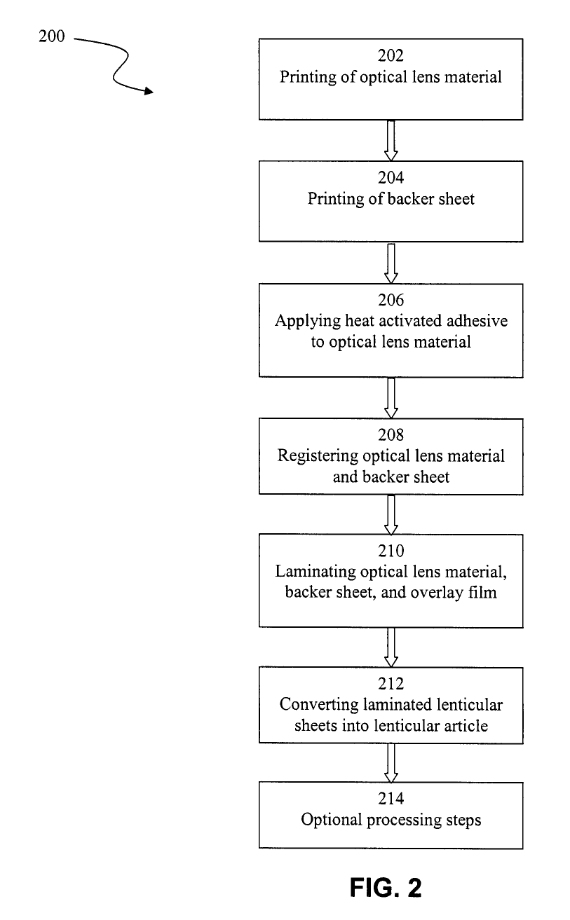

Referring to FIG. 2, in embodiments of the invention, dimensional image article 100 is manufactured by process 200. Although process 200 is directed to the specific manufacture of a lenticular article, it is understood that one of ordinary skill in the art would recognize that process 200 is not limited to lenticular articles but rather encompasses all dimensional image articles.

In a lenticular printing step 202, first ink layer 104 is printed on at least a portion of flat lens surface 118 of optical lens material 102 via any type of lithography, waterless offset, direct image waterless offset, flexography, any type of gravure, screen, rotary screen, silkscreen, letterpress, embossing, engraving, intaglio, digital printing such as inkjet, and like print methods or combinations thereof. In one embodiment of the invention, first ink layer 104 comprises a plurality of ink layers covering at least a portion of flat lens surface 118 to create the interlaced images. Optionally, at least one additional layer, such as, for example, a thermal protection layer, backing layer, adhesive layer, combinations thereof, and the like, may be applied over first ink layer 104.

In printing first ink layer 104, flat lens surface 118 is printed with corresponding interlaced images in conjunction with the appropriate mathematics of the optical lens material 102, as described above. In some embodiments, flat lens surface 118 of optical lens material 102 may be pre-coated with a primer to ensure better adhesion of first ink layer 104. This primer may be water-based, solvent-based, or UV-curable. Excellent ink adhesion is critical, as the ink forms the interlaced image to be viewed through lenticules 117. The pre-coating with a primer may be done via web or sheet fed operations or other suitable application methods.

In an alternative embodiment of the invention, lenticular printing step 202 can comprise application of first ink layer 104 to a separate substrate, such as a plastic film, paper, and other suitable materials. The substrate is then affixed to flat lens surface 118 by means of adhesive, thermal bonding, and other suitable affixing means.

One or more optional curing stations can by used to cure first ink layer 104 deposited on flat lens surface 118. In some embodiments, one or more optional curing stations, individually or as a group, can include air, thermal, infrared (IR), ultraviolet (UV), electron beam (EB), gamma, radio frequency (RF), and like sources or various combinations thereof.

In backer sheet printing step 204, second ink layer 110 is printed on second surface 122 of backer sheet 108 via any of a variety of suitable printing methodologies including, for example, lithography, waterless offset, direct image waterless offset, flexography, any type of gravure, screen, rotary screen, silkscreen, letterpress, embossing, engraving, intaglio, digital printing such as inkjet, and like print methods or combinations thereof. As with first ink layer 104, second surface 122 of backer sheet 108 can be pre-coated with a primer to ensure better adhesion of second ink layer 110. This primer may be water-based, solvent-based, or UV-curable. The pre-coating with a primer may be done via web or sheet fed operations or other suitable application methods.

In adhesive application step 206, first adhesive layer 106. First adhesive layer 106 is applied to at least a portion of flat lens surface 118. In one embodiment, first adhesive layer 106 is applied to at least a portion of flat lens surface 118 only. In another embodiment, first adhesive layer 106 is applied to at least a portion of flat lens surface 118 of optical lens material 102 and at least a portion of first surface 120 of backer sheet 108. First adhesive layer 106 can be applied by any of a variety of suitable application methods including roll coating, spray coating, curtain coating, screen coating, and the like or combinations thereof. In one representative embodiment of the invention, first adhesive layer 106 is applied by screen printing. First adhesive layer 106 is air-dried prior to further processing without activating the adhesive.

In an alternative embodiment, second adhesive layer 112 can be applied in adhesive application step 206, rather than pre-coated on overlay film 114. Second adhesive layer 112 is applied to at least a portion of second surface 122 of backer sheet 108 to cover second print layer 110. Similar to first adhesive layer 106, can be applied by any of a variety of suitable application methods including roll coating, spray coating, curtain coating, screen coating, and the like or combinations thereof.

In registration step 208, optical lens material 102 and backer sheet 108 are collated and registered to create an unlaminated lenticular assembly 124. Unlaminated lenticular assembly 124 can comprise optical lens material 102, first ink layer 104, first adhesive layer 106, backer sheet 108, and second ink layer 110. In an alternative embodiment, unlaminated lenticular assembly also comprises second adhesive layer 112. An adhesive, such as, for example, a water-based adhesive, is applied to the perimeter of lenticular assembly 124 to keep the optical lens material 102 and backer sheet 108 registered through processing. In some embodiments, the water-based adhesive can be applied to the perimeter of a stack of unlaminated lenticular assemblies such that the stack remains registered throughout processing.

In lamination step 210, registered lenticular assembly 124 is fed through heat compression laminator 126. Heat compression laminator 126 generally comprises a first or upper compression assembly 128 and a second or lower compression assembly 130, a cushioning assembly 132, and at least one heating unit 134. Suitable heat compression laminators can include belt laminators, heated nip rollers or drums, platen presses, and the like. Cushioning assembly 132 generally comprises a first take-up unit 138, a second-take up unit 140, and a cushioning material 142. Cushioning material 142 can comprise either a web or individualized cushioning sheets. Cushioning material 142 is depicted as a web in the system of FIGS. 3 and 4 for exemplary purposes only and is not limited to such. Cushioning material 142 is positioned between lower compression assembly 130 and ridge lens surface 116 of optical lens material 102.

Cushioning material 142 can comprise any of a variety of suitable cushioning materials such as, for example, polypropylene, polyethylene, flexible PVC, and other cushioning/insulating materials. In a preferred embodiment, cushioning material 142 is selected to have a lower melt temperature than optical lens material 102. Although cushioning material 142 can vary in thickness depending on the material used, cushioning material 142 should be at least thick enough to accept the height “h” of lenticule 117. In general, cushioning material 142 can comprise a thickness in a range from about 10 to about 80 mil. In one representative embodiment, cushioning material 142 comprises a 40 mil web of polypropylene.

Overlay film 114, precoated on one side with second adhesive layer 112, is positioned between upper compression assembly 128 and second major surface 122 of backer sheet 108 such that second adhesive layer 112 is proximate second major surface 122 with second ink layer 110. Heat and pressure are applied to lenticular assembly 124 to activate first adhesive layer 106 and second adhesive layer 112 so as to form a laminated lenticular sheet 148 with overlay film 114.

During lamination step 210, cushioning material 142 protects dimensional image article 100 and more specifically protects the lenses or lenticules 117 of ridged lens surface 116 from distortion by flattening, melting, and the like when subjected to heat and pressure from lower compression assembly 130. Generally, the lower melt temperature of cushioning material 142 compared to optical lens material 102 allows cushioning material 142 to flow into void areas 119 on ridged lens surface 116 to protect lenticules 117 from adverse distortion. Cushioning material 142 provides sufficient cushion so as to accept ridge lens surface 116, while allowing sufficient lamination of optical lens material 102 with backer sheet 108, and overlay film 114 with backer sheet 108.

In converting step 212, laminated lenticular sheet 148 can be converted into dimensional image article 100. Converting step 212 can comprise any of a variety of suitable converting techniques such as, for example, rotary die cutting, stamp cutting, laser die, punching, and the like converting methods.

In an optional finishing step 214, dimensional image article 100 can undergo additional processing steps such as, for example, collating, packaging, labeling, banding, molding, insertion into carriers and the like, imaging such addition and encoding of a magnetic stripe, post laminate printing such as concealing layers as discussed above, and any other suitable processing step or combinations thereof.

Referring to FIG. 3, a system 300 for manufacturing a dimensional image article 100 using a cushioning assembly 132 comprises at least one print station 150, at least one adhesive application unit 152, laminating station 154 including heat compression laminator 126 with cushioning assembly 132, and converting station 156. As discussed above, cushioning assembly 132 can comprise first take up unit 138, second take up unit 140, and cushioning material 142.

The heat compression laminator with cushioning assembly, methods and systems described above, produces a high quality, tamper proof or tamper evident dimensional image article 100 that can withstand heat and pressure during manufacturing without significant deformation. The heat activated adhesives provide a destructive bond between the optical lens material and backer sheet, and the overlay film and backer sheet. In particular, such apparatus, system and methods are used in conjunction with heat-activated adhesives that cure substantially clear or transparent to produce a dimensional image article, such as, for example, a clear, transparent, or semi-transparent lenticular card.

The invention may be embodied in other specific forms without departing from the essential attributes thereof; therefore, the illustrated embodiments should be considered in all respects as illustrative and not restrictive.

What is claimed is:

1. A method for making a dimensional image article, the method comprising:
providing an unlaminated dimensional image assembly having an optical lens material, a first ink layer, a first adhesive layer, a backer sheet, and a second ink layer, wherein the first adhesive layer comprises a heat-activated adhesive;
feeding the unlaminated dimensional image assembly into a compression laminator assembly having a cushioning material;
cushioning a ridged lens surface of the optical lens material with the cushioning material positioned between the ridged lens surface and the compression laminator assembly; and
applying heat and pressure to the unlaminated dimensional image assembly to activate the first adhesive layer to form a laminated dimensional image sheet.

2. The method of claim 1, further comprising:
converting the laminated dimensional image sheet into the dimensional image article.

3. The method of claim 1, wherein the application of heat and pressure to the unlaminated dimensional image assembly causes the ridged lens surface to be imprinted on a surface of the cushioning material proximate the ridged lens surface.

4. The method of claim 1, wherein the compression laminator assembly further comprises an upper compression assembly, a lower compression assembly, and an overlay film material.

5. The method of claim 4, wherein feeding the unlaminated dimensional image assembly into the compression laminator assembly further comprises positioning the cushioning material between the ridged lenticular surface and the lower compression assembly and positioning the overlay film material between the second ink layer and the upper compression assembly.

6. The method of claim 4, wherein the overlay film material comprises a second adhesive layer over a first surface of the overlay film material.

7. The method of claim 4, further comprising:
placing a data layer on a second surface of the overlay film material.

8. The method of claim 1, wherein ridges on the ridged lens surface occupy from about 10% to about 100% of the ridged lens surface.

9. The method of claim 1, wherein the cushioning material has a lower melt temperature than the optical lens material such that applying heat and pressure to the unlaminated dimensional image assembly results in flow of the cushioning material into void areas on the ridged lens surface.

10. A dimensional image article comprising:
a backer sheet having a first major surface and second major surface;
an optical lens material having a ridged lens surface and a flat lens surface;
a first ink layer printed on the flat lens surface defining a dimensional image; and
a first adhesive layer including a first heat activated adhesive, said first heat activated adhesive attaching the first major surface of the backer sheet to the flat lens surface of the optical lens material;

11. The dimensional image article of claim 10, further comprising:
an overlay film joined to at least a portion of the second major surface of the backer sheet.

12. The dimensional image article of claim 11, further comprising a data layer on a second surface of the overlay film material.

13. The dimensional image article of claim 11, wherein the backer sheet, the first adhesive layer, and the overlay film are transparent.

14. The dimensional image article of claim 11, further comprising:
a second adhesive layer such that the second adhesive operably joins the overlay film to the second major surface of the backer sheet.

15. The dimensional image article of claim 14, wherein the second adhesive layer comprises a second heat activated adhesive.

16. The dimensional image article of claim 15, wherein the first heat activated adhesive comprises the same adhesive formulation as the second heat activated adhesive.

17. The dimensional image article of claim 15, wherein the first heat activated adhesive and the second heat activated adhesive form a destructive bond.

18. The dimensional image article of claim 14, wherein the backer sheet, the first adhesive layer, the second adhesive layer, and the overlay film are semi-transparent.

19. The dimensional image article of claim 10, wherein the backer sheet is semi-opaque or opaque.

20. The dimensional image article of claim 10, wherein ridges on the ridged lens surface occupy from about 10% to about 100% of the ridged lens surface.

21. The dimensional image article of claim 10, wherein the optical lens material comprises a lenticular lens material, and said ridged lens surface defines a plurality of lenticules.

22. The dimensional image article of claim 21, wherein a radius of curvature of the plurality of lenticules is maintained across the ridged lens surface.

23. The dimensional image article of claim 10, wherein the dimensional image is interlaced and then printed on the flat lens surface.

24. The dimensional image article of claim 10, further comprising a second ink layer printed on the second major surface of the backer sheet defining a printed indicia.

25. The dimensional image article of claim 10, wherein at least a portion of the dimensional image article is transparent.

26. A laminator system for forming a laminated dimensional image article using heat activated adhesive comprising:
a heat compression assembly; and
a cushioning assembly having a cushioning material,
wherein an unlaminated dimensional image article is fed into the heat compression assembly to activate the heat activated adhesive within the unlaminated dimensional image article, and
wherein the cushioning material is positioned between the heat compression assembly and a ridged lens surface on the unlaminated dimensional image article, and
wherein the cushioning material has a cushioning thickness at least equal to a ridge height on the ridged lens surface.

27. The laminator system of claim 26, wherein the heat compression laminator assembly is selected from the group consisting of a belt laminator, a platen press, and a nip roller.

28. The laminator system of claim 26, wherein the cushioning thickness is from about 10 mils to about 100 mils.

29. The laminator system of claim 26, wherein the cushioning material comprises a sheet of cushioning material or a web of cushioning material.

30. The laminator system of claim 26, wherein the cushioning material comprises a material selected from the group consisting of polypropylene, polyethylene, and PVC.

31. The laminator system of claim 26, further comprising an overlay film assembly having an overlay film material.

32. The laminator system of claim 31, wherein the overlay film material comprises a second adhesive layer over a first surface of the overlay film material.

33. The laminator system of claim 26, wherein the heat compression assembly further comprises an upper compression assembly and a lower compression assembly.

34. The laminator system of claim 33, wherein the unlaminated dimensional image article comprises an optical lens material having a ridged lens surface, a first ink layer, a first adhesive layer, a backer sheet, and a second ink layer, wherein the first adhesive layer comprises a heat-activated adhesive.

35. The laminator system of claim 34, wherein the cushioning material is positioned between the ridged lens surface and the lower compression assembly, and an overlay film material is positioned between the second ink layer and the upper compression assembly.

36. The laminator system of claim 34, wherein the cushioning material has a lower melt temperature than the optical lens material such that applying heat and pressure to the unlaminated dimensional image article results in flow of the cushioning material into void areas on the ridged lens surface.

37. The laminator system of claim 26, wherein a data layer is placed on a second surface of the overlay film material.

38. The laminator system of claim 26, wherein ridges on the ridged lens surface occupy from about 10% to about 100% of the ridged lens surface.
